(19) United States
(12) Patent Application Publication
(10) Pub. No.: US 2013/0020770 A1
(43) Pub. Date: Jan. 24, 2013

(54) Brush seal

(71) Applicants: Jimmie Wade Hamilton, Pasadena, TX (US); Marc Wilburn Hickham, Friendswood, TX (US); James Wallace Greene, Pasadena, TX (US)

(72) Inventors: Jimmie Wade Hamilton, Pasadena, TX (US); Marc Wilburn Hickham, Friendswood, TX (US); James Wallace Greene, Pasadena, TX (US)

(21) Appl. No.: 13/135,860

(22) Filed: Jul. 18, 2011

(51) Int. Cl. F16J 15/44

(52) U.S. Cl. 277/355

(57) ABSTRACT

This invention relates to a method to improve the performance of standard brush seals for rotating shafts. This invention relates to a design that will lower manufacturing costs associated with standard brush seals for rotating shafts. This invention relates to a design that will improve wear characteristics of a standard brush seal. Specifically, the invention is intended to reduce manufacturing costs by combining the standard sealing element of a brush seal with the low cost materials and manufacturing methodologies of a carbon seal.

Specifically, the invention is intended to lower the overall weight of the brush seal assembly, thereby improving the life of the brush sealing element and reducing the wear characteristics on both the seal element and the associated shaft.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Brush seals are utilized in a wide variety of applications where high differential Pressures must be sealed against a rotating shaft. One of the most noteworthy applications is in the construction of both steam and gas turbines. Traditionally, highly precision carbon seals are used in these applications. Although carbon seals are inexpensive to manufacture, their sealing characteristics are poor in that they cannot come in direct contact with the associated shaft. The necessary gap assures that the abrasive carbon does not come in contact with the shaft being sealed, even during extreme thermal cycling. This necessary gap only marginally seals the application and allows a great deal of internal gas to pass through to the atmosphere or to other bearing components. Brush seals are commonly utilized to improve the sealing performance of these applications. However, brush seals have two distinct problems associated with the current state of the art.

First: Normally, a brush seal assembly is allowed to float in the seal housing of any given design so that it may normalize to the shaft being sealed. Because of the overall weight of current designs, brush seals require a heavy interference fit to the shaft. This heavy interference fit is principally done in an effort to extend the life of the seal by allowing greater eccentric wear as the seal drops during its life. This heavy interference fit does extend the life of the seal, however, it also decreases the life of the shaft. Because of the high loads associated with a fit of this nature, the shaft of the application is exposed to high abrasive loads that ultimately create unacceptable wear characteristics. Therefore, any brush seal design that can reduce the load of the interference fit will logically reduce shaft wear and extend the operational life of the equipment. This would have the effect of significantly lowering maintenance intervals, times to repair and remanufacturing costs.

Second: The design of currently available brush seals requires that they are imbedded into a heavy metal assembly, which must be manufactured against demanding tolerances. This, in turn, forces manufacturing costs up, which affects the selling price of the finished seal. In many cases a brush seal might be as much as 50 times costlier than its carbon counterpart. The high cost of current brush seal assemblies reduces their popularity and limits the number of applications that might otherwise use these seals. Therefore, any brush seal design that can significantly reduce manufacturing costs will provide a finished assembly that can be offered at a cost that will better compete with the more traditional carbon seals.

### BRIEF SUMMARY OF INVENTION

The invention is a unique arrangement of components that takes advantage of the low material costs and manufacturing costs associated with carbon, or other low cost, high performance materials, to improve the performance and lower the manufacturing costs of a brush seal. A brush seal element is embedded into a carbon, or other low cost, high performance material, carrier which carries a face groove and a counter bore. The face groove accepts the brush seal, which is held in place by pressing a carbon, or other low cost, high performance material, cap piece into the counter bore. Similarly, the carbon, or other low cost, high performance material, carrier can be designed to fix the seal element by bonding with glue, solder or integral molding.

### BRIEF DESCRIPTION OF DRAWINGS

FIG. 1. is an exploded view of the invention using 5 pieces.

FIG. 2. is an exploded view of the invention using 3 pieces.

FIG. 3. is a sectional view of the 5 piece preferred embodiment.

FIG. 4. is a sectional view of the 3 piece preferred embodiment.

### DETAILED DESCRIPTION OF THE INVENTION

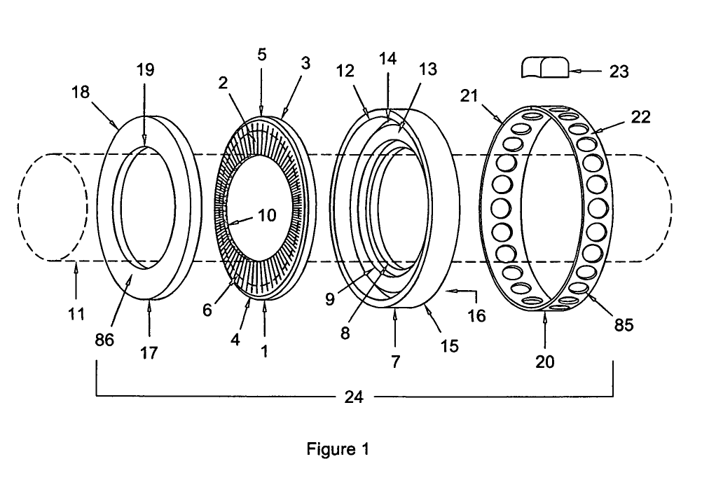

FIG. 1. The brush seal element 1 is constructed by welding wires 2 in a radial arrangement onto a ring 3. The weld 4 follows the face and outer edge of the ring 3. The ring 3 forms an outside diameter 5 and an inside diameter 6. The seal element is set into the carrier 7, which is made from carbon or some other low cost, high performance material. The carrier 7 has a through hole 8 with a counter bore 9. The counter bore 9 is intended to allow the wires 2 that form the sealing diameter 10 the ability to float and therefore conform to the shaft 11 being sealed. A larger counter bore 12 forms a seat 13 for the seal element 1 to rest on. The outer diameter of the counter bore 12 is equipped with a groove 14 that accepts the ring 3 of the brush seal element 1. The outer diameter 15 is manufactured to match the inside diameter 21 of the retention ring 20. The back side 16 of the carrier 7 forms a face seal that is manufactured to match the intended application. The seal element 1 is secured into the carrier 7 by pressing a retention ring 17 into the counter bore 12. The outside diameter 18 of the retention ring 17 is matched to the counter bore 12. The retention ring 17 carries a clearance hole 19 to accommodate the shaft 11 being sealed. The front face 86 of the retention ring 17 forms a face seal that is manufactured to match the intended application. The carrier 7 is reinforced against cracking by pressing a reinforcing ring 20 onto the outside diameter 15. The inside diameter 21 of the reinforcing ring 20 is matched to the outside diameter 15 of the carrier 7. The reinforcing ring 20 may be perforated with a series of holes 85 intended to lighten the overall assembly 24. The outside diameter 22 of the reinforcing ring 20 is manufactured to match the intended application. A key is fixed to the outside diameter 23 of the retention ring 20 to control rotation of the overall assembly 24 after it has been installed into its intended application. The key 23 is manufactured and positioned to match the intended application.

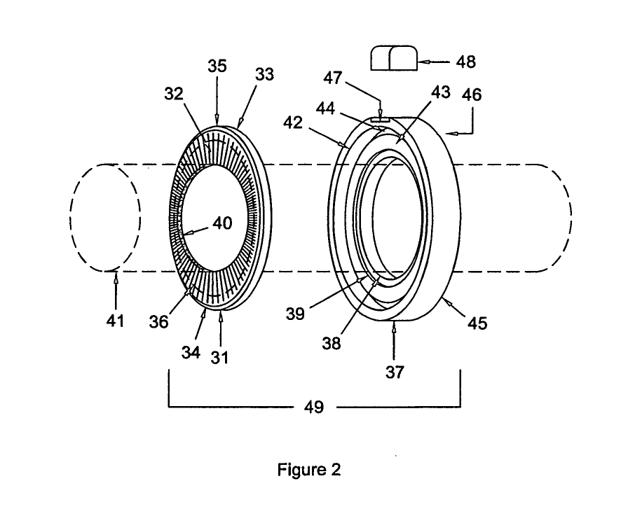

FIG. 2. The brush seal element 31 is constructed by welding wires 32 in a radial arrangement onto a ring 33. The weld 34 follows the face and outer edge of the ring 33. The ring 33 forms an outside diameter 35 and an inside diameter 36. The seal element is set into the carrier 37 which is made from carbon or some other low cost, high performance material. The carrier 37 has a through hole 38 with a counter bore 39. The counter bore 39 is intended to allow the wires 32 that form the sealing diameter 40 the ability to float and therefore conform to the shaft 41 being sealed. A larger counter bore 42 forms a seat 43 for the seal element 31 to rest on. The outer diameter of the counter bore 42 is equipped with a groove 44 that accepts the ring 33 of the brush seal element 31. The outer diameter 45 is manufactured to match the intended application. The back side 46 of the carrier 37 forms a face seal that is manufactured to match the intended application. The seal element 31 is secured into the carrier 37 by bonding with ceramic glue, solder or some other bonding agent within the groove 44. The outside diameter 45 of the carrier 37 is manufactured to match the intended application. A key seat 47 is cut into the outside diameter 45 of the carrier 37. A key 48 is matched to the key seat 47 and is intended to control rotation of the overall assembly 49 after it has been installed into its intended application. The key seat 47 is positioned to match the intended application. The key 48 is manufactured to match the intended application.

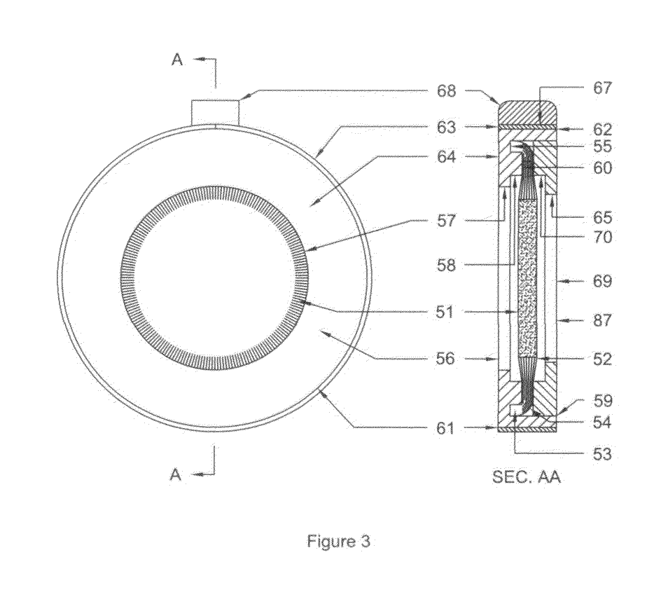

Preferred Embodiment: FIG. 3. Specific dimensions are omitted from this description because the embodiment can be scaled to fit a wide variety of size applications. The brush seal element 51 is constructed by welding wires 52 in a radial arrangement onto a machined ring 53. The weld 54 follows the face and outer edge of the ring 53. The ring 53 dimensionally matches a groove 55 cut into the carrier 56. The seal element is set into the carrier 56, which is manufactured from carbon or some other low cost, high performance material. The carrier 56 has a through hole 57 with a counter bore 58. The outer diameter 61 is manufactured to match the inside diameter 62 of the retention ring 63. The face 64 of the carrier 56 forms a face seal that is manufactured to match the intended application. The seal element 51 is secured into the carrier 56 by pressing a retention ring 69 into the counter bore 59. The outside diameter of the retention ring 69 is matched to the counter bore 59. The retention ring 69 carries a clearance hole 65 and a counter bore 70. The face 87 of the retention ring 69 forms a face seal that is manufactured to match the intended application. A reinforcing ring 63 is pressed onto the outside diameter 61 of the carrier 56. The inside diameter 62 of the reinforcing ring 63 is matched to the outside diameter 61 of the carrier 56. The outside diameter 67 of the reinforcing ring 63 is manufactured to match the intended application. A key 68 is fixed to the outside diameter 67 of the retention ring 66. The key 68 is manufactured and positioned to match the intended application.

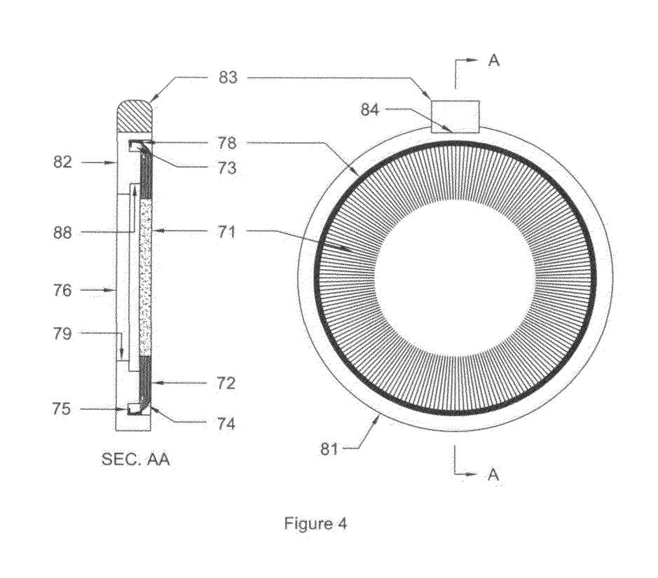

FIG. 4. Specific dimensions are omitted from this description because the embodiment can be scaled to fit a wide variety of size applications. The brush seal element 71 is constructed by welding wires 72 in a radial arrangement onto a machined ring 73. The weld 74 follows the face and outer edge of the ring 73. The ring 73 dimensionally matches a groove 75 cut into the carrier 76. The seal element is set into the carrier 76 which is manufactured from carbon or other high performance, low cost material. The seal element 71 is bonded into the groove 75 with ceramic glue, solder or other bonding agent 78. The carrier 76 has a through hole 79 with a counter bore 88. The face 82 of the carrier 76 forms a face seal that is manufactured to match the intended application. A key 83 is matched to a key seat 84 cut into the outside diameter 81 of the carrier 76. The key seat 84 is positioned to match the intended application. The key 83 is manufactured to match the intended application.

What is claimed is:

1. A brush seal configuration that may be manufactured at a reduced cost.

2. A brush seal configuration that will provide superior sealing characteristics.

3. A brush seal configuration that will provide extended life.

4. A brush seal configuration that will reduce wear on the mating components.

5. A brush seal configuration whose carrier is manufactured from carbon.

6. A brush seal configuration whose carrier is manufactured from a low cost, high performance material.

7. A brush seal configuration whose sealing element is bonded into its carrier.

8. A brush seal configuration whose sealing element is pressed into its carrier.

9. A brush seal configuration that utilizes a retention ring.

10. A brush seal configuration that utilizes a reinforcing ring.
